(19) United States
(12) Patent Application Publication
(10) Pub. No.: US 2016/0021342 A1
(43) Pub. Date: Jan. 21, 2016

(54) DEVICE AND METHOD FOR DETERMINATION

(71) Applicant: Panasonic Intellectual Property Corporation of America, Torrance, CA (US)

(72) Inventors: MITSUHIRO ASO, Osaka (JP); MASAO NONAKA, Osaka (JP)

(21) Appl. No.: 14/795,937

(22) Filed: Jul. 10, 2015

(30) Foreign Application Priority Data
Jul. 18, 2014 (JP) 2014-147973

(51) Int. Cl. H04N 7/18; G01B 11/00; G05B 15/02; H04N 5/232; G06K 9/00

(52) U.S. Cl. CPC H04N 7/18; H04N 5/23212; H04N 5/23296; G06K 9/00288; G05B 15/02; G01B 11/00

(57) ABSTRACT

A determination device in a storage apparatus includes a door determiner that determines whether any of a door of a first storage unit and a door of a second storage unit has been opened, the first and the second storage units being included in the storage apparatus, the first storage unit horizontally storing a first article, and the second storage unit vertically storing a second article, and a storage/retrieval determiner that detects a first change in a horizontal position of first the article if the door of the first storage unit has been opened, detects a second change in a vertical position of the second article if t the door of the second storage unit has been opened, and determines whether the first article has been stored based on the detected first change and whether the second article has been stored based on the detected second change.

### BACKGROUND

1. Technical Field

The present disclosure relates to a determination device that determines whether an article has been stored in or retrieved from a storage apparatus including at least first and second storage units for storing articles.

2. Description of the Related Art

Household electrical appliances have been made multifunctional in recent years. For example, there have been proposed refrigerators having a traditional function of storing foodstuffs at low or freezing temperatures, as well as a function of managing the stock of foodstuffs (e.g., Japanese Unexamined Patent Application Publication Nos. 2000-310476 and 2003-42626).

### SUMMARY

However, further improvements have to be made to the technologies of Japanese Unexamined Patent Application Publication Nos. 2000-310476 and 2003-42626.

In one general aspect, the techniques disclosed here feature a determination device in a storage apparatus includes a door determiner that determines whether any of a door of a first storage unit and a door of a second storage unit has been opened, the first and the second storage units being included in the storage apparatus, the first storage unit horizontally storing a first article, and the second storage unit vertically storing a second article, and a storage/retrieval determiner that detects a first change in a horizontal position of the first article if the door of the first storage unit has been opened, detects a second change in a vertical position of the second article if the door of the second storage unit has been opened, and determines whether the first article has been stored based on the detected first change and whether the second article has been stored based on the detected second change.

According to the present disclosure, whether an article has been stored or retrieved can be determined properly.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a drawing showing an example of an overview of a stock management service according to the embodiment of the present disclosure;

FIG. 1B is a drawing showing an example in which the data center operating company is a device manufacturer;

FIG. 1C is a drawing showing an example in which the data center operating company consists of a device manufacturer and a different management company;

FIG. 2 is a drawing showing an example of a refrigerator and a camera according to the embodiment of the present disclosure;

FIG. 3A is a drawing showing an example of the state in which a revolving door of the refrigerator is opened;

FIG. 3B is a drawing showing an example of the state in which a drawer door the refrigerator is opened;

FIG. 4 is a diagram showing an example configuration of a determination device of the embodiment of the present disclosure;

FIG. 5A is a drawing showing a change in the horizontal position of the color barcode when the revolving door is opened;

FIG. 5B is a drawing showing a change in the vertical position of the color barcode when the drawer door is opened.

FIG. 6 is a flowchart showing an example of the steps of a storage/retrieval determination process performed by the determination device according to the present embodiment;

FIG. 7 is a flowchart showing an example of the steps of a storage/retrieval determination process performed by the determination device according to the present embodiment;

FIG. 8 is a drawing showing an example of a method for determining whether a foodstuff has been stored in or retrieved from a first storage unit or a pocket;

FIG. 9 is a drawing showing the hardware configuration of a computer that implements the functions of devices on the basis of a program;

FIG. 10 is a diagram showing a service type (company's own data center type);

FIG. 11 is a diagram showing a service type (IaaS type);

FIG. 12 is a diagram showing a service type (PaaS type); and

FIG. 13 is a diagram showing a service type (SaaS type).

### DETAILED DESCRIPTION

### Underlying Knowledge Forming Basis of the Present Disclosure

Japanese Unexamined Patent Application Publication No. 2000-310476 discloses a storage apparatus that includes multiple sensors disposed at the entrances of the storage apparatus and intended to read information from RFID tags attached to stored foodstuffs. The storage apparatus manages the storage and retrieval of the foodstuffs by detecting the moving directions of the RFID tags using these sensors.

Japanese Unexamined Patent Application Publication No. 2003-42626 discloses a refrigerator that includes multiple doors and a camera. The camera captures images of the inside of the refrigerator by automatically changing the imaging direction in accordance with the position of an opened door. Thus, the user can check the internal state of the refrigerator.

However, Japanese Unexamined Patent Application Publication No. 2000-310476 determines the moving directions of the foodstuffs on the basis of the order in which the sensors read information from the RFID tags. For this reason, this technology has a problem that the sensors have to be previously provided at the entrances of the storage apparatus.

Japanese Unexamined Patent Application Publication No. 2003-42626 changes the imaging direction of the camera in accordance with the position of an opened door, but does not disclose any method for recognizing the storage and retrieval of individual foodstuffs. For this reason, it has a problem that it cannot properly recognize the storage and retrieval of the foodstuffs.

In view of the foregoing, the inventor has conceived of the following modifications.
(1) A determination device according to one aspect of the present disclosure is a determination device in a storage apparatus. The determination device includes a door determiner that determines whether any of a door of a first storage unit and a door of a second storage unit has been opened based on a result of a detection by a sensor included in the storage apparatus, the first and the second storage units being included in the storage apparatus, the first storage unit horizontally storing a first article, and the second storage unit vertically storing a second article, and a storage/retrieval determiner that detects a change in a horizontal position of the first article if the door determiner determines that the door of the first storage unit has been opened, detects a change in a vertical position of the second article if the door determiner determines that the door of the second storage unit has been opened, and determines whether the first article has been stored based on the detected change in the horizontal position of the first article and whether the second article has been stored based on the detected change in the vertical position of the second article.
(2) In the above aspect, if the door determiner determines that the door of the first storage unit has been opened and if the storage/retrieval determiner detects the horizontal position of the first article has been changed from a first position to a second position in the first storage unit, the storage/retrieval determiner may determine that the first article has been stored, the second position being farther from the door of the first storage unit than the first position. If the door determiner determines that the door of the second storage unit has been opened and if the storage/retrieval determiner detects the vertical position of the second article has been changed from a third position to a fourth position, the storage/retrieval determiner may determine that the second article has been stored, the fourth position being farther from the door of the second storage unit than the third position.
(3) In the above aspect, the determination device may further include a camera controller that controls focus of a camera installed in the storage apparatus. If the door determiner determines that the door of the first storage unit has been opened, the camera controller may cause the camera to focus on a first area at height direction of the first storage unit. If the door determination unit determines that the door of the second storage unit has been opened, the camera controller may cause the camera to focus on a second area in an upper part of the second storage unit. The storage/retrieval determiner may detect a change in the horizontal position of the first article from a first image captured by the camera under control of the camera controller, and may detect a change in the vertical position of the second article from a second image captured by the camera under control of the camera controller.
(4) In the above aspect, the camera controller may further control pan and zoom of the camera. If the door determiner determines that the door of the first storage unit has been opened, the camera controller may cause the camera to pan. If the door determiner determines that the door of the second storage unit has been opened, the camera controller may cause the camera to zoom.
(5) In the above aspect, the determination device may further include a lighting system that illuminates the first article and the second article. A second distance from a position of the lighting system to the second storage unit may be longer than a first distance from the position of the lighting system to the first storage unit. If the door determiner determines that the door of the second storage unit has been opened, the camera controller may control the lighting system so that the lighting system illuminates the second article with stronger light than light with which the lighting system illuminates the first article when the door determiner determines that the door of the first storage unit has been opened.
(6) In the above aspect, the storage/retrieval determiner may further identify a person who has stored the article, from a third image of the person captured by the camera.
(7) In the above aspect, the storage/retrieval determiner may determine whether the first article has been retrieved based on the detected change in the horizontal position of the first article and whether the second article has been retrieved based on the detected change in the vertical position of the second article..
(8) In the above aspect, if the first article is registered in a database as an article already stored in the storage apparatus, the storage/retrieval determiner may determine that the first article has been retrieved and if the second article is registered in the database as the article already stored in the storage apparatus, the storage/retrieval determiner may determine that the second article has been retrieved, the database being connected to the determination device.

Now, an embodiment of the present disclosure will be described in detail with reference to the accompanying drawings.

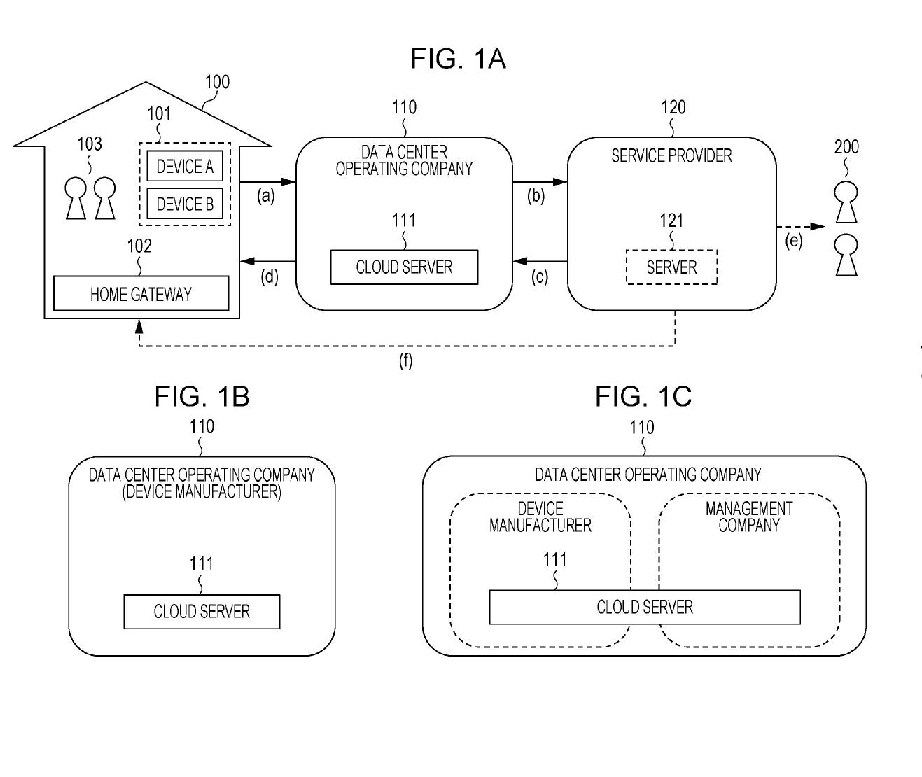

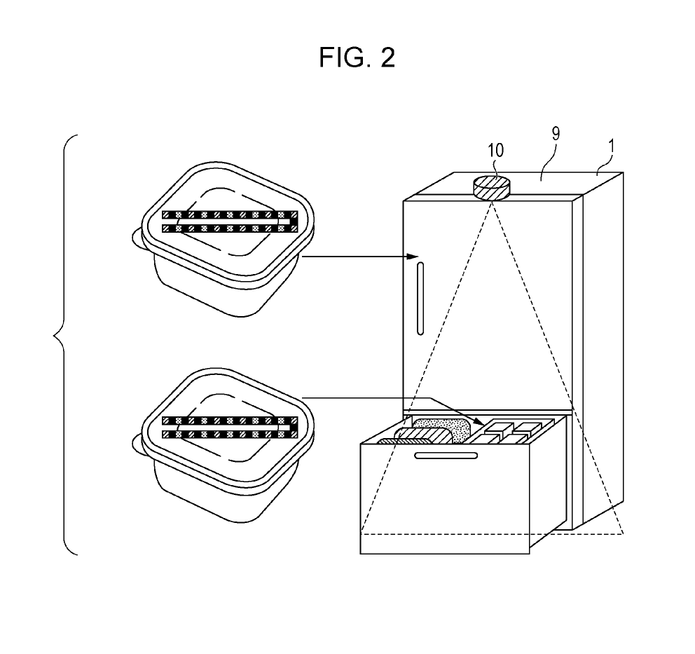

First, there will be described overviews of stock management services according to the embodiment of the present disclosure. FIGS. 1A and 2B are drawings showing overviews of stock management services according to the embodiment of the present disclosure. FIG. 1A shows an example of an overview of a stock management service according to the embodiment of the present disclosure. A group 100 is a group such as a company, organization, or household and may have any size.

The group 100 includes multiple devices 101 consisting of devices A and B, and a home gateway 102. The devices 101 include devices which can be connected to the Internet (e.g., smartphone, PC, TV) and devices which cannot be connected to the Internet by themselves (e.g., refrigerator, microwave oven, lighting system, washer).

The devices 101 may include devices which cannot be connected to the Internet by themselves but can be connected thereto through the home gateway 102. The group 100 also includes users 103 who use the devices 101.

A data center operating company 110 includes a cloud server 111. The cloud server 111 is a virtual server that cooperates with various devices through the Internet. The cloud server 111 mostly manages big data or the like, which is difficult to handle using a typical database management tool or the like.

The data center operating company 110 performs the management of data, the management of the cloud server 111, the operation of a data center which performs those, and the like. Details of the operation performed by the data center operating company 110 will be described later.

The data center operating company 110 is not limited to a company which only performs the management of data, the operation of the cloud server 111, and the like. FIG. 1B shows an example in which the data center operating company 110 is a device manufacturer.

For example, if a device manufacturer which develops and manufactures one of the devices 101 also performs the management of data, the management of the cloud server 111, and the like, the device manufacturer corresponds to a data center operating company 110 as shown in FIG. 1 B.

Further, the number of data center operating companies 110 is not limited to one. FIG. 1C shows an example in which the data center operating company 110 consists of a device manufacturer and a different management company. For example, if a device manufacturer and a different management company manage data or operate the cloud server 111 in a joint or shared manner, one or both thereof serves as the data center operating company 110, as shown in FIG. 1C.

Referring back to FIG. 1A, a server provider 120 holds a server 121. The server 121 may have any size and may be, for example, a memory in a PC. The service provider 120 need not necessarily hold the server 121.

In the above service, the home gateway 102 is not essential. For example, if the cloud server 111 manages all data, there is no need for the home gateway 102. There are also cases in which there are no devices which cannot be connected to the Internet by themselves, like cases in which all devices in the household are connected to the Internet.

Next, the flow of information in the above service will be described. First, the devices A and B in the group 100 transmit log information thereof to the cloud server 111 of the data center operating company 110. The cloud server 111 accumulates log information from the devices A and B (FIG. 1A).

As used herein, the log information refers to, for example, information indicating the status, date/time, or the like of the operation of each device. More specific examples of the log information include information about the storage or retrieval of foodstuffs in or from a storage apparatus such as a refrigerator, the date/time and frequency of the opening and closing of the door of the storage apparatus, information about cooking using a microwave oven, histories of the viewing of a television, information about the programmed recording using a video recorder, the date/time of the operation of a washer, and the amount of laundry. However, the log information is not limited to those described above and is all information which can be acquired from all the devices.

Log information may be directly provided from the devices 101 to the cloud server 111 through the Internet. Log information from the devices 101 may be temporarily accumulated in the home gateway 102 and then provided from the home gateway 102 to the cloud server 111.

Next, the cloud server 111 of the data center operating company 110 provides a predetermined amount of the accumulated log information to the service provider 120. The predetermined amount may be an amount obtained by organizing the information accumulated in the data center operating company so that the information can be provided to the service provider 120, or may be an amount requested by the service provider 120. Further, the amount of log information to be provided need not necessarily be predetermined and may be changed according to the situation.

The log information is stored in the server 121 held by the service provider 120 as necessary (FIG. 1B). The service provider 120 organizes the log information into information suitable for a service to be provided to each user and then provides the resulting information to the user.

Users to which the above information is provided may be the users 103, who use the devices 101, or may be external users 200. The above information may be provided from the service provider directly to the users [(e) of FIG. 1A] or may be provided to the users again through the cloud server 111 of the data center operating company 110 [(c), (d) of FIG. 1A].

Alternatively, the cloud server 111 of the data center operating company 110 may organize the log information into information suitable for a service to be provided to each user and then provide the resulting information to the service provider 120.

Note that the users 103 and users 200 may be the same or different.

Referring now to FIG. 2, there will be described a refrigerator 1 and a camera 10 according to the embodiment of the present disclosure. FIG. 2 is a drawing showing an example of the refrigerator 1 and camera 10 according to the embodiment of the present disclosure.

Described in the present embodiment is a case in which a foodstuff is stored in or retrieved from the refrigerator 1 having two storage units. However, the present disclosure is not limited to such a case and can be applied to refrigerators having three or more storage units.

Further, while the refrigerator 1 for storing foodstuffs is described below as an embodiment of the present disclosure, the present disclosure can be applied to any storage apparatuses for storing articles.

As shown in FIG. 2, the camera 10 is disposed on an upper part 9 of the refrigerator 1. More specifically, the camera 10 is disposed on the upper part 9 of the refrigerator 1 in such a manner that it can capture images of identification information attached to a foodstuff stored in a first storage unit or second storage unit when the door of the first storage unit or the door of the second storage unit is opened.

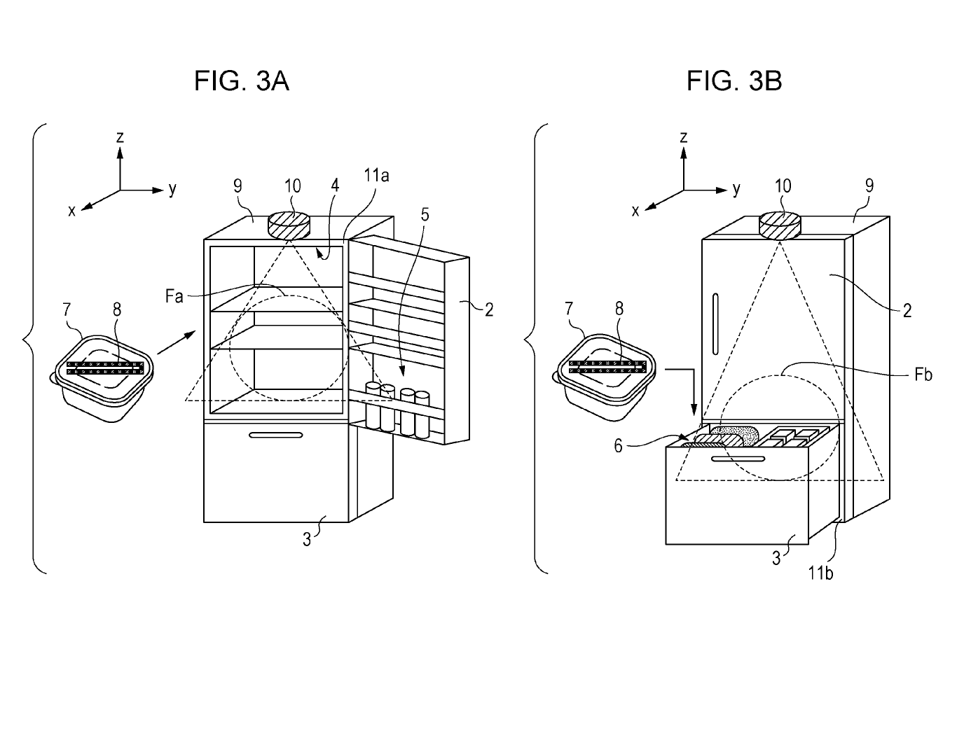

Referring now to FIG. 3, there will be described in detail the configuration of the refrigerator 1 according to the embodiment of the present disclosure. FIGS. 3A and 3B are drawings showing an example configuration of the refrigerator 1 according to the embodiment of the present disclosure. FIG. 3A shows an example of the state in which a revolving door 2 of the refrigerator 1 is opened, whereas FIG. 3B shows an example of the state in which a drawer door 3 thereof is opened.

FIGS. 3A and 3B also show x-y-z Cartesian coordinate systems. In the examples of FIGS. 3A and 3B, the x-axis represents the depth direction of the refrigerator 1; the y-axis represents the width direction thereof; and the z-axis represents the height direction thereof.

The refrigerator 1 includes the first storage unit 4 having the revolving door 2, the second storage unit 6 having the drawer door 3, the camera 10, door open/close sensors 11a and 11b, and a determination device 12. Note that the determination device 12 is not shown in FIG. 3A or 3B since it is built in the refrigerator 1 in the present embodiment. Alternatively, the determination device 12 may be mounted on the refrigerator 1 externally.

The revolving door 2 has a pocket 5. The revolving door 2 is rotated about an axis parallel with the z-axis, whereas the drawer door 3 is drawn out in the positive direction of the x-axis.

A foodstuff 7 is an article stored in the refrigerator 1, and identification information for identifying the foodstuff 7 is attached to a surface thereof. In the present embodiment, a color barcode 8 is used as an example of the identification information.

However, the identification information is not limited to the color barcode 8 and may be any type of identification information as long as information for identifying the foodstuff 7 can be extracted from images of the identification information captured by the camera 10.

The imaging direction of the camera 10 is the negative direction of the z-axis. When the foodstuff 7 is stored in the first storage unit 4 or second storage unit 6 or when the foodstuff 7 is retrieved from the first storage unit 4 or second storage unit 6, the camera 10 captures images of the color barcode 8 attached to the foodstuff 7 to recognize the foodstuff 7 and the moving direction thereof.

When the foodstuff 7 is stored in the first storage unit 4, it moves approximately along an x-y plane, as shown in FIG. 3A. When the foodstuff 7 is stored in the second storage unit 6, it moves approximately along the z-axis.

The door open/close sensor 11a detects whether the revolving door 2 has been opened or closed, whereas the door open/close sensor 11b detects whether the drawer door 3 has been opened or closed.

Based on information indicating the state detected by the door open/close sensor 11a or 11b, the camera 10 pans, zooms, or focuses and then captures images of the color barcode 8.

Specifically, when the door open/close sensor 11a detects that the revolving door 2 has been opened, the camera 10 pans so that appropriate images of the color barcode 8 can be captured. Note that the camera may capture moving images or may capture still images continuously.

For the pan of the camera 10, if the foodstuff 7 moves in the positive direction of the x-axis and then in the negative direction thereof, the camera 10 pans sequentially in the respective directions so that the camera can follow the movements of the foodstuff and captures images in the respective directions.

For the order in which the camera 10 pans, if the foodstuff 7 moves in the negative direction of the x-axis and then in the position direction thereof, the camera 10 may pan sequentially in the respective directions so that the camera can follow the movements of the foodstuff.

Thus, whether the foodstuff 7 is stored or retrieved, the camera 10 can capture appropriate images of the color barcode 8.

Further, if it is determined that the revolving door 2 has been opened, the camera 10 focuses on a first area Fa at the height of the first storage unit 4. Thus, in-focus images of the color barcode 8 can be captured.

On the other hand, when the door open/close sensor 11b detects that the drawer door 3 has been opened, the camera 10 zooms so that appropriate images of the color barcode 8 can be captured.

At this time, the camera 10 first zooms in and captures images and then zooms out and captures images. Alternatively, the camera 10 may first zoom out and then zoom in.

Thus, whether the foodstuff 7 is stored or retrieved, appropriate images of the color barcode 8 can be captured.

Further, if it is determined that the drawer door 3 has been opened, the camera 10 focuses on a second area Fb at a lower height than that of the first area Fa. Thus, in-focus images of the color barcode 8 can be captured.

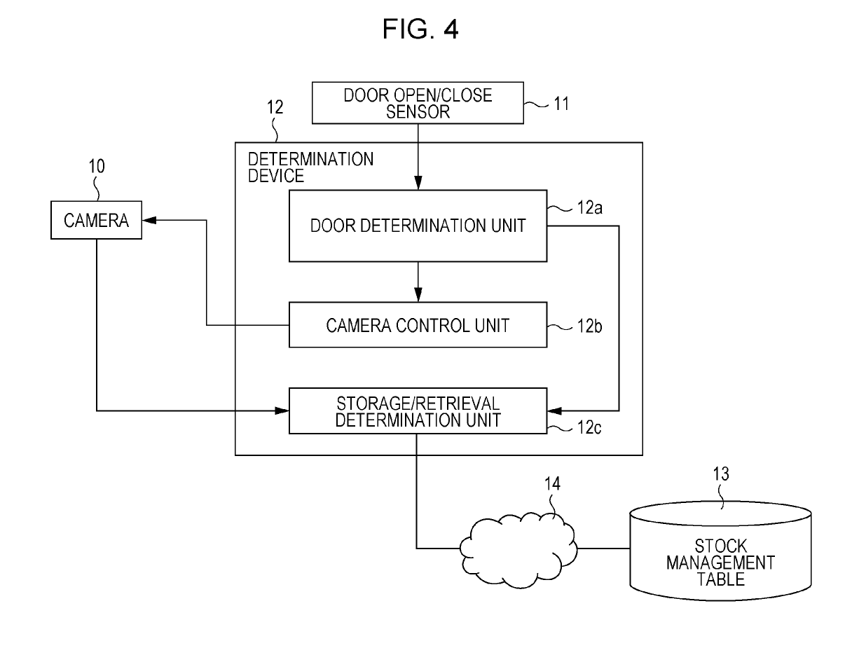

Referring now to FIG. 4, there will be described the configuration of the determination device 12 according to the embodiment of the present disclosure. FIG. 4 is a diagram showing an example configuration of the determination device 12 of the embodiment of the present disclosure.

As shown in FIG. 4, the determination device 12 includes a door determination unit 12a, a camera control unit 12b, and a storage/retrieval determination unit 12c. The determination device 12 is connected to the camera 10 and door open/close sensor 11 described with reference to FIG. 3. The door open/close sensor 11 corresponds to both the door open/close sensors 11a and 11b.

The determination device 12 is also connected to a cloud server through a network 14. The cloud server is, for example, the cloud server 111 shown in FIG. 1. The storage unit of the cloud server is storing a stock management table 13.

The door determination unit 12a determines whether any of the revolving door 2 of the first storage unit 4 and the drawer door 3 of the second storage unit 6 has been opened.

Specifically, the door determination unit 12a acquires, from the door open/close sensor 11, information as to whether the revolving door 2 has been opened or closed or whether the drawer door 3 has been opened or closed. The door determination unit 12a then determines whether any of the revolving door 2 of the first storage unit 4 and the drawer door 3 of the second storage unit 6 has been opened.

The door determination unit 12a then transmits the determination to the camera control unit 12b and storage/retrieval determination unit 12c.

Based on the determination from the door determination unit 12a, the camera control unit 12b controls the pan, zoom, or focus of the camera 10, the timing of imaging, and like. Specifically, if the door determination unit 12a determines that the revolving door 2 of the first storage unit 4 has been opened, the camera control unit 12b causes the camera 10 to pan; if the door determination unit 12a determines that the drawer door 3 of the second storage unit 6 has been opened, the camera control unit 12b causes the camera 10 to zoom.

After the camera 10 pans or zooms, the camera control unit 12b causes the camera 10 to focus as described above, based on the determination as to whether the revolving door 2 has been opened or whether the drawer door 3 has been opened.

The storage/retrieval determination unit 12c determines whether the foodstuff 7 has been stored in the first storage unit 4 or second storage unit 6 or whether the foodstuff 7 has been retrieved from the first storage unit 4 or second storage unit 6.

Specifically, the storage/retrieval determination unit 12c acquires the images of the color barcode 8 captured by the camera 10. The storage/retrieval determination unit 12c also acquires, from the door determination unit 12a, the determination as to whether any of the revolving door 2 of the first storage unit 4 and the drawer door 3 of the second storage unit 6 has been opened.

The storage/retrieval determination unit 12c then extracts, from the images of the color barcode 8, the ID information of the foodstuff embedded in the color barcode 8.

If the determination is a determination that the revolving door 2 of the first storage unit 4 has been opened, the storage/retrieval determination unit 12c detects a change in the horizontal position of the color barcode 8 identifying the foodstuff 7. If the determination is a determination that the drawer door 3 of the second storage unit 6 has been opened, the storage/retrieval determination unit 12c detects a change in the vertical position of the color barcode 8.

Based on the detection result, the storage/retrieval determination unit 12c determines whether the foodstuff having the color barcode 8 attached thereto has been stored in the first storage unit 4 or second storage unit 6 or retrieved from the first storage unit 4 or second storage unit 6. A method for making this determination will be described in detail later.

The storage/retrieval determination unit 12c then transmits, to the cloud server storing the stock management table 13, ID information for identifying the refrigerator 1, the ID information of the foodstuff 7 extracted from the color barcode 8, and the determination as to whether the foodstuff corresponding to that ID information has been stored or retrieved.

The stock management table 13 is a database in which the ID information for identifying the refrigerator 1 and information about each foodstuff stored in the refrigerator 1 are stored in a manner associated with each other. Based on the information from the determination device 12, the cloud server updates the information registered in the stock management table 13.

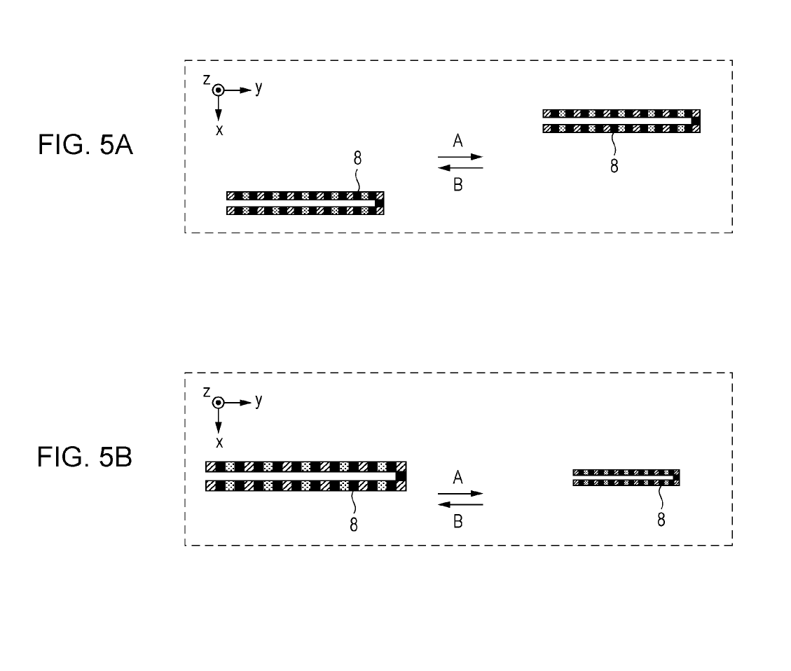

Referring now to FIG. 5, there will be described a method for determining whether the foodstuff 7 has been stored or retrieved. FIGS. 5A and 5B are drawings showing a storage/retrieval determination method according to the present embodiment.

FIG. 5A shows a change in the horizontal position of the color barcode 8 when the revolving door 2 is opened. In this case, the position of the color barcode 8 changes on an x-y plane.

When the position of the color barcode 8 has changed in the negative direction of the x-axis (arrow A) in FIG. 5A, the storage/retrieval determination unit 12c determines that the foodstuff 7 has been stored. On the other hand, when the position of the color barcode 8 has changed in the position direction of the x-axis (arrow B), the storage/retrieval determination unit 12c determines that the foodstuff 7 has been retrieved.

In this case, the camera 10 pans and then focuses. Thus, it is possible to prevent the camera 10 from failing to capture images of the color barcode 8 or prevent the color barcode 8 falling out of focus.

The pan of the camera 10 has been described above. Alternatively, the camera 10 may only focus without panning, and the storage/retrieval determination unit 12c may detect a change in the horizontal position of the color barcode 8 from captured moving images or continuously captured still images using a typical image recognition technology and then determine whether the foodstuff 7 has been stored or retrieved.

Thus, the present disclosure can be applied to even a camera 10 which does not have a pan function.

FIG. 5B shows a change in the vertical position of the color barcode 8 when the drawer door 3 is opened. A change in the size of the color barcode 8 indicates that the position of the color barcode 8 has changed in a direction along the z-axis.

In this case, the camera 10 zooms and then focuses. Specifically, the storage/retrieval determination unit 12c recognizes the color barcode 8 in images captured by the camera 10. If the storage/retrieval determination unit 12c determines that the color barcode 8 has decreased in size in the images captured by the camera 10, the camera 10 zooms in.

On the other hand, if the storage/retrieval determination unit 12c determines that the color barcode 8 has increased in size, the camera 10 zooms out.

Thus, it is possible to prevent the color barcode 8 from becoming too large or too small or falling out of focus.

When the color barcode 8 has decreased in size in FIG. 5B (arrow A) and thus the camera 10 has zoomed in, the storage/retrieval determination unit 12c determines that the foodstuff 7 has been stored. On the other hand, when the color barcode 8 has increased in size (arrow B), the storage/retrieval determination unit 12c determines that the foodstuff 7 has been retrieved.

The zoom of the camera 10 has been described above. Alternatively, the camera 10 may only focus without zooming, and the storage/retrieval determination unit 12c may determine whether the color barcode 8 has decreased or increased in size, from captured moving images or continuously captured still images using a typical image recognition technology and then determine whether the foodstuff 7 has been stored or retrieved.

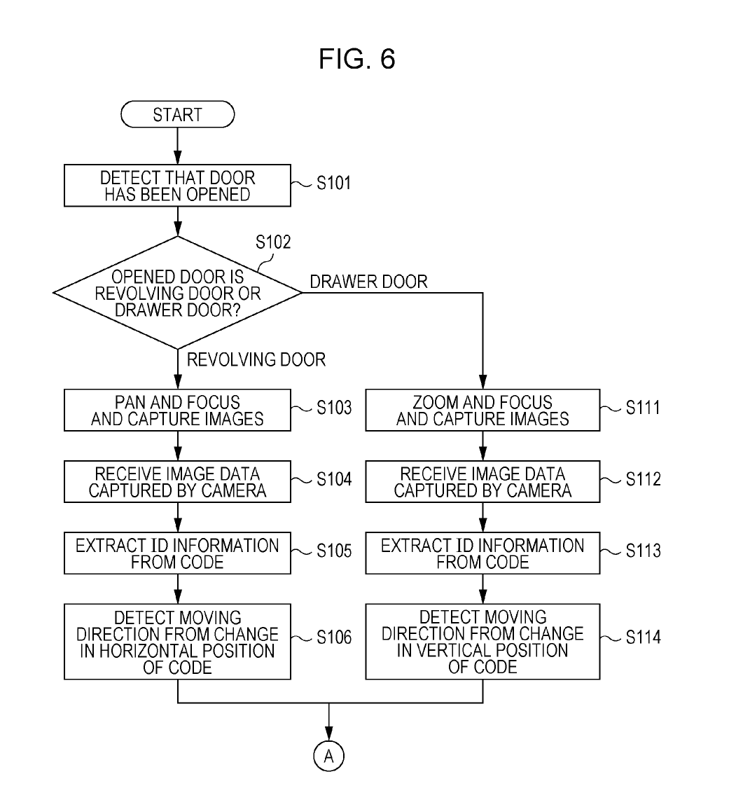

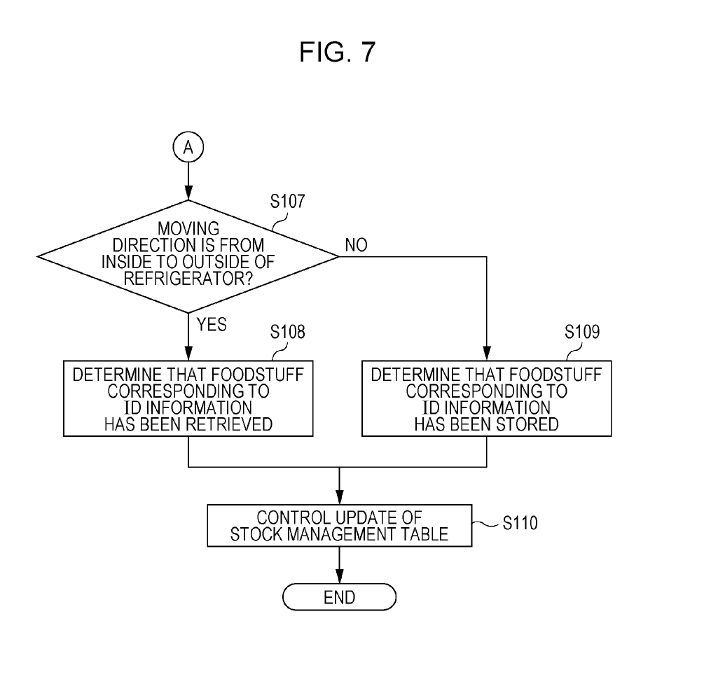

Referring now to FIGS. 6 and 7, there will be described an example of the steps of a storage/retrieval determination process performed by the determination device 12. FIGS. 6 and 7 are flowcharts showing an example of the steps of a storage/retrieval determination process performed by the determination device 12 according to the present embodiment.

As shown in FIG. 6, first, the door open/close sensor 11 detects that one of the doors of the refrigerator 1 has been opened and notifies the door determination unit 12a of the detection result (S101).

Based on the detection result from the door open/close sensor 11, the door determination unit 12a determines whether the opened door is the revolving door 2 or drawer door 3 and transmits the determination to the camera control unit 12b and the storage/retrieval determination unit 12c (S102).

If the received determination is a determination that the opened door is the revolving door 2, the camera control unit 12b causes the camera 10 to pan and focus and then to capture images of the color barcode (S103). Subsequently, the storage/retrieval determination unit 12c receives image data of the images captured by the camera 10 (S104).

The storage/retrieval determination unit 12c then extracts the ID information of the foodstuff 7 from the color barcode 8 included in the images (S105). The storage/retrieval determination unit 12c also detects the moving direction of the color barcode 8 from a change in the horizontal position of the color barcode 8 (S106).

Subsequently, as shown in FIG. 7, the storage/retrieval determination unit 12c determines whether the detected moving direction of the color barcode 8 is the direction from inside to outside of the refrigerator (the positive direction of the x-axis) (S107).

If the moving direction of the color barcode 8 is the direction from inside to outside of the refrigerator, the storage/retrieval determination unit 12c determines that a foodstuff corresponding to the extracted ID information has been retrieved (S108).

In contrast, if the moving direction of the color barcode 8 is not the direction from inside to outside of the refrigerator but the direction from outside to inside thereof (the negative direction of the x-axis), the storage/retrieval determination unit 12c determines that a foodstuff corresponding to the extracted ID information has been stored (S109).

The storage/retrieval determination unit 12c then causes the cloud server to update the stock management table 13 stored in the cloud server on the basis of this determination (S110). Thus, the storage/retrieval determination process ends. Specifically, the storage/retrieval determination unit 12c transmits, to the cloud server, the ID information for identifying the refrigerator 1, the ID information extracted from the color barcode 8, and the determination as to whether the foodstuff corresponding to the extracted ID information has been stored or retrieved and causes the cloud server to update information about the stock of the foodstuffs in the refrigerator 1 registered in the stock management table 13.

If the door determination unit 12a determines in S102 shown in FIG. 6 that the opened door is the drawer door 3, the camera control unit 12b causes the camera 10 to zoom and focus and then capture images of the color barcode 8 (S111). Subsequently, the storage/retrieval determination unit 12c receives image data of the images captured by the camera 10 (S112).

The storage/retrieval determination unit 12c then extracts the ID information of the foodstuff 7 from the color barcode 8 included in the images (S113). The storage/retrieval determination unit 12c also detects the moving direction of the color barcode 8 from a change in the vertical position of the color barcode 8 (S106).

The storage/retrieval determination unit 12c then performs steps S107 to S110 shown in FIG. 7.

As described above, in the present embodiment, the storage/retrieval determination unit 12c determines whether the foodstuff 7 has been stored in the first storage unit 4 or second storage unit 6 or whether the foodstuff 7 has been retrieved from the first storage unit 4 or second storage unit 6.

However, the present disclosure is not limited to this determination and the storage/retrieval determination unit 12c may further determine whether the foodstuff 7 has been stored in or retrieved from the pocket 5 shown in FIG. 3A.

In this case, whether the foodstuff 7 has been stored in or retrieved from the second storage unit 6 is determined using a method similar to that described in the present embodiment.

For this reason, there will be described below a method for determining whether the foodstuff 7 has been stored in the first storage unit 4 or pocket 5 or whether the foodstuff 7 has been retrieved from the first storage unit 4 or pocket 5.

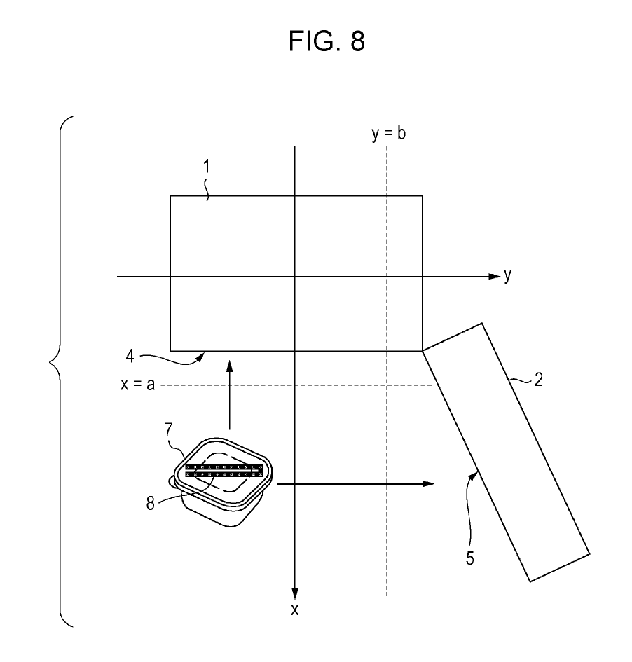

FIG. 8 is a drawing showing an example of a method for determining whether the foodstuff 7 has been stored in or retrieved from the first storage unit 4 or pocket 5. While the camera 10 is not shown in FIG. 8, it is assumed that the camera 10 is disposed as shown in FIG. 3A and the like.

In this method also, when the door open/close sensor 11a detects that revolving door 2 has been opened, the camera 10 may or may not pan. The camera 10 may capture moving images or may capture still images continuously.

For the direction in which the camera 10 pan, if the door determination unit 12a determines that the foodstuff 7 has been moved in the position direction of the x-axis, the camera 10 pans in that direction so that it can follow the foodstuff 7 and then captures images; subsequently, if the door determination unit 12a determines that the foodstuff 7 has been moved in the negative direction of the x-axis, the camera 10 pans in that direction so that it can follow the foodstuff 7 and then captures images; subsequently, if the door determination unit 12a determines that the foodstuff 7 has been moved in the position direction of the y-axis, the camera 10 pans in that direction so that it can follow the foodstuff 7 and then captures images; and subsequently, if the door determination unit 12a determines that the foodstuff 7 has been moved in the negative direction of the y-axis, the camera 10 pans in that direction so that it can follow the foodstuff 7 and then captures images. The order of the directions in which the camera 10 pans may be different from the above order.

Thus, whether the foodstuff 7 has been stored in the first storage unit 4 or pocket 5 or whether the foodstuff 7 has been retrieved from the first storage unit 4 or pocket 5, appropriate images of the color barcode 8 can be captured.

Further, the camera 10 focuses on the first area Fa at the height of the first storage unit 4 and pocket 5 (see FIG. 3A). Thus, in-focus images of the color barcode 8 can be captured.

When the position of the color barcode 8 has changed in the negative direction of the x-axis and gone beyond a straight line x=a (a is a predetermined value) as shown in FIG. 8, the storage/retrieval determination unit 12c determines that the foodstuff 7 has been stored in the first storage unit 4.

On the other hand, when the position of the color barcode 8 has changed in the position direction of the x-axis and gone beyond the straight line x=a, the storage/retrieval determination unit 12c determines that the foodstuff 7 has been retrieved from the first storage unit 4.

When the position of the color barcode 8 has changed in the position direction of the y-axis and gone beyond a straight line y=b (b is a predetermined value) as shown in FIG. 8, the storage/retrieval determination unit 12c determines that the foodstuff 7 has been stored in the pocket 5.

On the other hand, when the position of the color barcode 8 has changed in the negative direction of the y-axis and gone beyond the straight line y=b, the storage/retrieval determination unit 12c determines that the foodstuff 7 has been retrieved from the pocket 5.

Note that the above determination cannot be performed in a range of x≦a and y≧b. In this case, the storage/retrieval determination unit 12c may notify the user that no determination can be made, for example, by emitting a sound, or may urge the user to store or retrieve the foodstuff 7 in or from ranges other than the above range.

Further, the value of b in the straight line y=b may be changed according to the degree of opening of the revolving door 2, that is, the rotational angle of the revolving door 2. The storage/retrieval determination unit 12c may also determine that the foodstuff 7 has been retrieved from the pocket 5, based on whether the foodstuff 7 has gone beyond a straight line which is parallel with the revolving door 2 and rotates according to the rotational angle of the revolving door 2, rather than the straight line y=b. In this case, the rotational angle of the revolving door 2 may be recognized, for example, by the camera 10.

In the above embodiment, the foodstuff 7 is identified by attaching the color barcode 8 to the foodstuff 7 and extracting the ID information of the foodstuff 7 from the color barcode 8. However, the present disclosure is not limited to this method.

For example, the storage/retrieval determination unit 12c may identify the foodstuff 7 by extracting the color, size, shape, or the like of the foodstuff 7 from the images. In this case, information such as the colors, sizes, shapes, or the like of the foodstuffs stored in the refrigerator 1 is registered in the stock management table of the cloud server. The storage/retrieval determination unit 12c may determine whether the foodstuff 7 is among the foodstuffs stored in the refrigerator 1, by checking the information.

Further, a lighting system for illuminating the foodstuff 7 may be disposed adjacent to the camera 10. In this case, if the door determination unit 12a determines that the drawer door 3 of the second storage unit 6, which is more distant from the camera 10 than the first storage unit 4, has been opened, the camera control unit 12b controls the lighting system so that the lighting system illuminates the foodstuff 7 with stronger light than that when the door determination unit 12a determines that the revolving door 2 of the first storage unit 4 has been opened.

Thus, a favorable environment for capturing images of the foodstuff 7 can be created, so that the recognition accuracy of the color barcode 8 can be further improved. Note that the lighting system need not necessarily be disposed adjacent to the camera 10.

Further, a person who has stored or retrieved the foodstuff 7 may be identified. In this case, the camera 10 captures images of the foodstuff 7, as well as images of the person who has stored or retrieved the foodstuff 7, and the storage/retrieval determination unit 12c identifies the person by recognizing the captured images.

Thus, if multiple persons use a single refrigerator 1, the stock of the foodstuff 7 can be managed on a person basis in the stock management table 13 or the like of the cloud server.

In the above embodiment, if the moving direction of the color barcode 8 attached to the foodstuff 7 is the direction from inside to outside of the refrigerator, the storage/retrieval determination unit 12c determines that the foodstuff 7 has been retrieved. Alternatively, if the foodstuff 7 is registered in the stock management table 13 as an article already stored in the refrigerator 1, the storage/retrieval determination unit 12c may determine that the foodstuff 7 has been retrieved.

In this case, the storage/retrieval determination unit 12c determines whether the ID information of the foodstuff 7 extracted from the color barcode 8 is registered in the stock management table 13. Thus, whether the foodstuff 7 has been retrieved can be determined easily.

While, in the above embodiment, the camera 10 is disposed on the upper part 9 of the refrigerator 1, the camera 10 may be disposed in other positions. Further, multiple camera 10 may be disposed so that images of the color barcode 8 can be captured regardless of the angle of the foodstuff 7.

The embodiment of the present disclosure has been described in detail with reference to the drawings. The functions of the devices such as the determination device 12 can be implemented by a computer program.

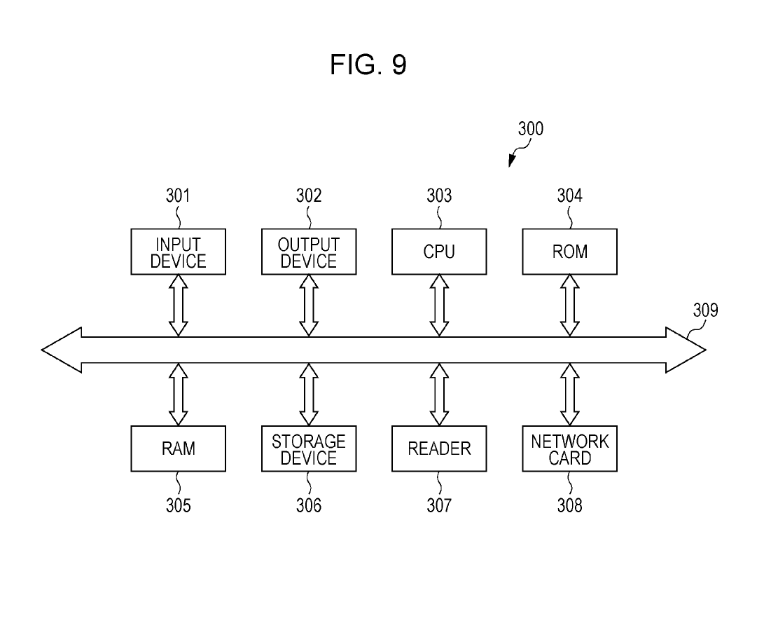

FIG. 9 is a drawing showing the hardware configuration of a computer 300 that implements the functions of the devices on the basis of a program.

For example, the computer 300 includes an input device 301 such as a keyboard, mouse, or touchpad, an output device 302 such as a display or speaker, a CPU 303, a read-only memory (ROM) 304, a random access memory (RAM) 305, a storage device 306 such as a hard disk drive or solid state drive (SSD), a reader 307 that reads information from a recording medium such as a digital versatile disk read-only memory (DVD-ROM) or universal serial bus (USB) memory, and a network card 308 that performs communication through a network. The respective devices are connected together through a bus 309.

The reader 307 reads a program for implementing the functions of the devices from a recording medium and stores the program in the storage device 306. Alternatively, the network card 308 communicates with a server connected to a network, downloads a program for implementing the functions of the devices from the server, and stores the program in the storage device 306.

The CPU 303 copies the program stored in the storage device 306 to the RAM 305, and sequentially reads commands included in the program from the RAM 305 and executes the commands. Thus, the functions of the devices are implemented.

The technology described in the above embodiment can be implemented, for example, in the following types of cloud services. However, the types as which the technology described in the above embodiment can be implemented are not limited thereto.
Service type 1: company's own data center type

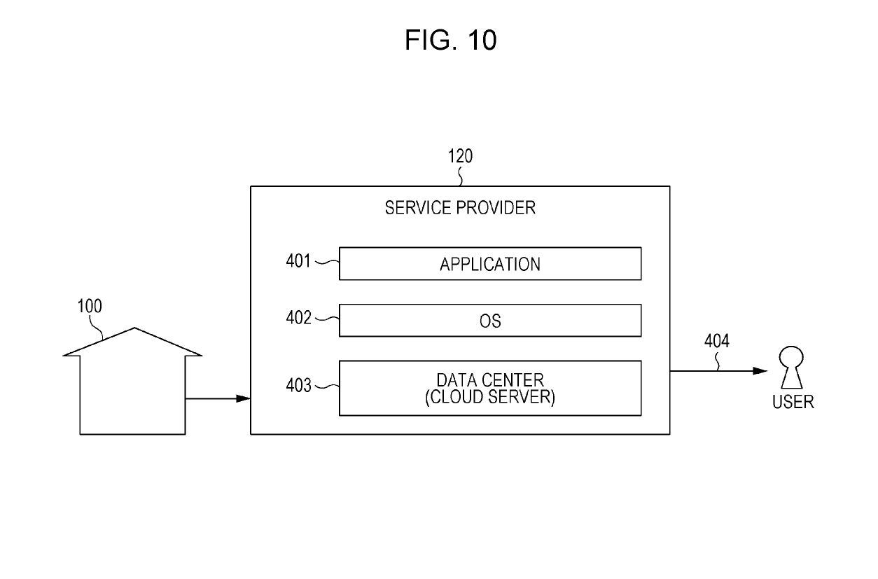

FIG. 10 is a diagram showing server type 1 (company's own data center type). In the present type, a service provider 120 acquires information from a group 100 and provides a service to a user. The service provider 120 has the functions of a data center operating company. That is, the service provider holds a cloud server 111 which manage big data. Accordingly, there is no data center operating company.

In the present type, the service provider 120 operates and manages a data center 403 [cloud server 111 (see FIG. 1A)]. The service provider 120 also manages an OS 402 and an application 401 and performs service provision 404 using the OS 402 and application 401.
Service type 2: IaaS type

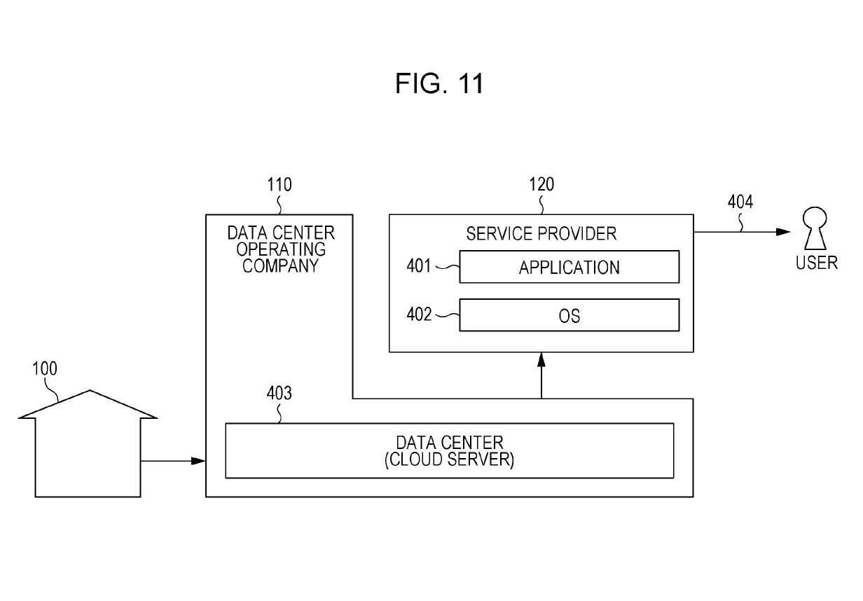

FIG. 11 is a diagram showing server type 2 (IaaS type). As used herein, IaaS is the abbreviation of infrastructure as a service and is a cloud service provision model which provides an infrastructure for constructing and operating a computer system, as a service through the Internet.

In the present type, a data center operating company operates and manages a data center 403 [cloud server 111 (see FIG. 1)]. A service provider 120 manages an OS 402 and an application 401 and performs service provision 404 using the OS 402 and application 401.
Service type 3: PaaS type

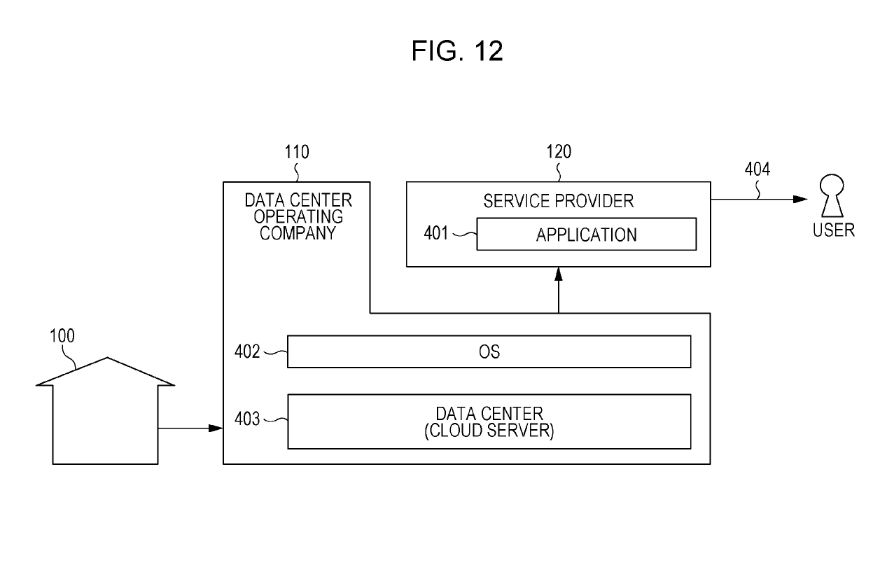

FIG. 12 is a diagram showing service type 3 (PaaS type). As used herein, PaaS is the abbreviation of platform as a service and is a cloud service provision model which provides a platform serving as an infrastructure for constructing and operating software, as a service through the Internet.

In the present type, a data center operating company 110 manages an OS 402, and operates and manages a data center 403 [cloud server 111 (see FIG. 1)]. A service provider 120 manages an application 401 and performs service provision 404 using the OS 402 managed by the data center operating company and the application 401 managed by the server provider 120.
Service type 4: SaaS type

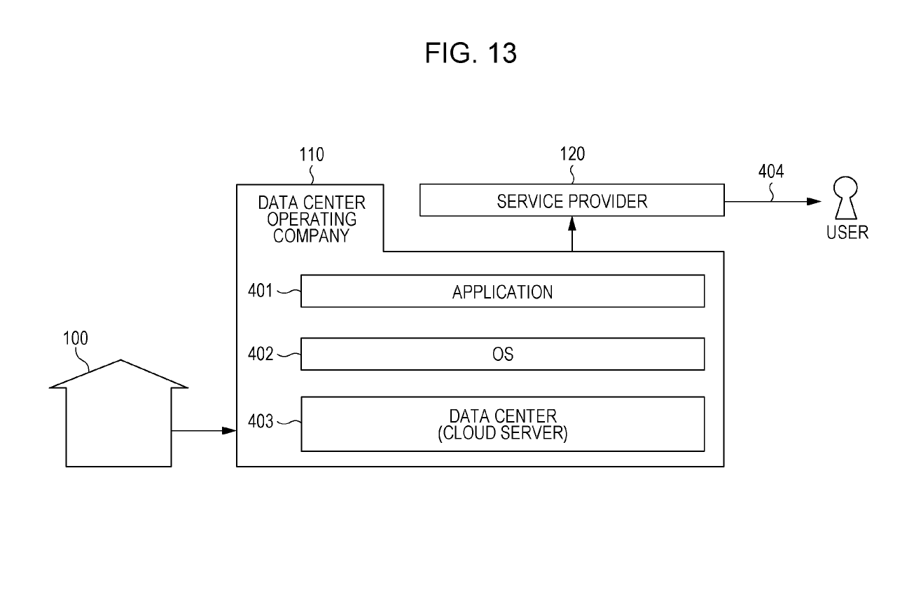

FIG. 13 is a diagram showing server type 4 (SaaS type). As used herein, SaaS is the abbreviation of software as a service and is, for example, a cloud service provision model which allows companies or individuals (users) not holding a data center (cloud server) to use an application provided by a platform provider holding a data center (cloud server) through a network such as the Internet.

In the present type, a data center operating company 110 manages an application 401 and an OS 402, and operates and manages a data center 403 [cloud server 111 (see FIG. 1)]. A service provider 120 performs service provision 404 using the OS 402 and application 401 managed by the data center operating company 110.

As seen above, in any type, the service provider 120 provides services. For example, the service provider 120 or data center operating company 110 may develop an OS, application, a database of big data, or the like on its own or may outsource such development to a third party.

The device and method for determination according to the present disclosure are suitable for determining whether an article has been stored in or retrieved from a storage apparatus including at least first and second storage units for storing articles.

1. A determination device in a storage apparatus, comprising:
a door determiner that determines whether any of a door of a first storage unit and a door of a second storage unit has been opened based on a result of a detection by a sensor included in the storage apparatus, the first and the second storage units being included in the storage apparatus, the first storage unit horizontally storing a first article, and the second storage unit vertically storing a second article, and
a storage/retrieval determiner that detects a change in a horizontal position of the first article if the door determiner determines that the door of the first storage unit has been opened, detects a change in a vertical position of the second article if the door determiner determines that the door of the second storage unit has been opened, and determines whether the first article has been stored, based on the detected change in the horizontal position of the first article and whether the second article has been stored based on the detected change in the vertical position of the second article.

2. The determination device according to claim 1, wherein
if the door determiner determines that the door of the first storage unit has been opened and if the storage/retrieval determiner detects the horizontal position of the first article has been changed from a first position to a second position in the first storage unit, the storage/retrieval determiner determines that the first article has been stored, the second position being farther from the door of the first storage unit than the first position, and
if the door determiner determines that the door of the second storage unit has been opened and if the storage/retrieval determiner detects the vertical position of the second article has been changed from a third position to a fourth position, the storage/retrieval determiner determines that the second article has been stored, the fourth position being farther from the door of the second storage unit than the third position.

3. The determination device according to claim 1, further comprising a camera controller that controls focus of a camera installed in the storage apparatus, wherein
if the door determiner determines that the door of the first storage unit has been opened, the camera controller causes the camera to focus on a first area at a height direction of the first storage unit,
if the door determiner determines that the door of the second storage unit has been opened, the camera controller causes the camera to focus on a second area in an upper part of the second storage unit, and
the storage/retrieval determiner detects a change in the horizontal a position of the first article from a first image captured by the camera under control of the camera controller, and detects a change in the vertical position of the second article from a second image captured by the camera under control of the camera controller.

4. The determination device according to claim 3, wherein
the camera controller further controls pan and zoom of the camera,
if the door determiner determines that the door of the first storage unit has been opened, the camera controller causes the camera to pan, and
if the door determiner determines that the door of the second storage unit has been opened, the camera controller causes the camera to zoom.

5. The determination device according to claim 3, further comprising a lighting system that illuminates the first article and the second article, wherein
a second distance from a position of the lighting system to the second storage unit is longer than a first distance from the position of the lighting system to the first storage unit, and
if the door determiner determines that the door of the second storage unit has been opened, the camera controller controls the lighting system so that the lighting system illuminates the second article with stronger light than light with which the lighting system illuminates the first article when the door determiner determines that the door of the first storage unit has been opened.

6. The determination device according to claim 3, wherein the storage/retrieval determiner further identifies a person who has stored the article, from an a third image of the person captured by the camera.

7. The determination device according to claim 1, wherein
the storage/retrieval determiner determines whether the first article has been retrieved based on the detected change in the horizontal position of the first article and whether the second article has been retrieved based on the detected change in the vertical position of the second article.

8. The determination device according to claim 1, wherein if the first article is registered in a database as an article already stored in the storage apparatus, the storage/retrieval determiner determines that the first article has been retrieved and if the second article is registered in the database as the article already stored in the storage apparatus, the storage/retrieval determiner determines that the second article has been retrieved, the database being connected to the determination device.

9. A method for making a determination in a storage apparatus, comprising:
determining whether any of a door of a first storage unit and a door of a second storage unit has been opened based on a result of a detection by a sensor included in the storage apparatus, the first and the second storage units being included in the storage apparatus, the first storage unit horizontally storing a first article, and the second storage unit vertically storing a second article; and
detecting a change in a horizontal position of the first article if it is determined that the door of the first storage unit has been opened;
detecting a change in a vertical position of the second article if it is determined that the door of the second storage unit has been opened; and
determining whether the first article has been stored based on the detected change in the horizontal position of the first article and whether the second article has been stored based on the detected change in the vertical position of the second article.
